(19) United States
(12) Patent Application Publication
(10) Pub. No.: US 2012/0132481 A1
(43) Pub. Date: May 31, 2012

(54) Fall Arrest System

(75) Inventor: Karl Jones, Devizes (GB)

(73) Assignee: Latchways PLC, Devizes (GB)

(21) Appl. No.: 13/144,073

(22) PCT Filed: Jan. 12, 2010
(86) PCT No.: PCT/GB10/00039

§ 371 Date: Jan. 17, 2012

(30) Foreign Application Priority Data
Jan. 12, 2009 (GB) 0900435.9

(51) Int. Cl. A62B 35/04

(52) U.S. Cl. 182/230

(57) ABSTRACT

A fall arrest safety system has a traveller arranged to travel along a safety line and including a securing arrangement deployable in response to a fall event to secure the traveller in fixed position on the safety line. An energy absorber device is connected intermediately between the traveller and the user, the energy absorber device including a plastically deformable energy absorber deployable in response to a fall event to plastically deform from a stowed orientation to a deployed orientation. The energy absorber may have a coil-form portion and an elongate tongue portion extending in a linear direction at the periphery of the coil-form portion, the elongate tongue portion of the energy absorber being arranged to extend to project from the housing for connection to a karabiner, lanyard or other connection device.

The present invention relates to a fall arrest system, and particularly to a fall arrest system including a safety line extending vertically or inclined significantly upwardly, such as are used when ascending/descending structures such as buildings or towers using attached ladders or otherwise.

Such arrangements may conveniently utilise attachment devices (commonly referred to s traveller devices) that are connected to travel upwardly or downwardly along a vertically or upwardly extending safety line cable being dragged by a user. The cable is typically fixed to the building or other structure (e.g. a tower) which is being ascended or descended. The traveller devices typically have a self locking line grip or clamp that is activated in response to a fall event (when a user falls) thereby applying a predetermined load to the traveller device and deploying the clamp or grip of the traveller device to grip the safety line cable to secure the traveller device in a fixed position relative to the safety line cable. The traveller device is typically connected by a karabiner or other connection to a flexible lanyard connected to the user. Examples of such fall arrest arrangements are disclosed in, for example EP0272782 and W095/26784. In the arrangement of EP0272782, the cam clamp 27 is deployed during a fall arrest event in order to clamp the safety line cable 11.

It is desirable to include in a fall arrest system an energy absorber arrangement in order to minimise the reaction shock to the user when the fall is arrested. In such vertical or near vertical fall arrest systems this is frequently achieved by means of a tearable webbing arrangement comprising the lanyard or other harness article worn by the user.

An improved arrangement has now been devised.

According to a first aspect of the present invention, there is provided a fall arrest safety system comprising:
a traveller device arranged to travel along a safety line and including a securing arrangement deployable in response to a fall event to secure the traveller in fixed position on the safety line;
an energy absorber device connected intermediately between the traveller device and the user, the energy absorber device including a plastically deformable energy absorber deployable in response to a fall event to plastically deform from a stowed orientation to a deployed orientation.

It is preferred that, in deployment the energy absorber acts to lengthen the separation distance between the point of attachment to the user and the traveller device.

A rigid connection is preferably provided between the traveller device and the energy absorber device. This I preferably in the form of a rigid connection arm. The rigid connection arm is preferably pivotally connected to the traveller device and/or the energy absorber device. Beneficially movement of the rigid connection arm effects deployment of the securing arrangement to secure the traveller in fixed position on the safety line.

It is preferred that the energy absorber comprises a metallic element deployed to be drawn along a deployment path about a deformer to a plastically deformed extended state in order to absorb energy in a fall arrest event.

Beneficially the energy absorber device includes an energy absorber comprising a coil form element which is deployed from a coil form state to a plastically deformed extended state in order to absorb energy in a fall arrest event. During deployment t is preferred that the coil-form portion rotates about an axis

Preferably, in deployment the energy absorber is drawn to plastically deform about a rotatable deformer element.

In a preferred embodiment, in the un-deployed state, the energy absorber has:
a coil-form portion; and,
an elongate tongue portion extending in a linear direction at the periphery of the coil-form portion.

Beneficially, the elongate tongue portion is spaced from the periphery of the coil-form portion of the energy absorber. It is preferred that intermediate between the coil form portion and the linear portion, the energy absorber has a curved linking portion. This arrangement calls for the strip to follow a serpentine deployment path ensuring good energy absorbance characteristics during plastic deformation.

It is preferred that the curved linking portion extends to be curved about a deformer element; and/or is curved in an opposed sense to the curvature of the coil form portion adjacent the curved linking portion.

In a preferred embodiment the energy absorber comprises a plastically deformable metallic strip.

Typically, the energy absorber comprises connection means for connecting the energy absorber to a user connected item such as a karabiner or lanyard. In one embodiment, the connection means may comprise an eyelet provided through the energy absorber.

In one embodiment it is preferred that the energy absorber is provided in a chassis or housing comprising the energy absorber device, the energy absorber being drawn out of the chassis or housing during deployment to a plastically deformed extended state in order to absorb energy in a fall arrest event.

Beneficially, in the un-deployed state an elongate tongue portion of the energy absorber extends in a linear direction to project from the chassis or housing.

In such an embodiment it may be preferred that the elongate tongue portion projecting from the housing is provided with a cover coating or sheath; and/or an eyelet for connection to a karabiner, lanyard or other connection device.

Beneficially, the traveller device includes a clamp or grip element which is deployed to clamp or grip the safety line to secure the traveller in the fixed position on the safety line in response to the fall event.

The fall arrest system of the present invention is particularly suited for use with an upwardly extending safety line.

According to a second aspect, the invention provides energy absorber device for a fall arrest system, the device comprising:
a chassis or housing;
an energy absorber disposed in the chassis or housing and having a coil-form portion and an elongate tongue portion extending in a linear direction at the periphery of the coil-form portion, the elongate tongue portion of the energy absorber being arranged to extend to project from the chassis or housing and provided with means for connection to a karabiner, lanyard or other connection device.

According to a further aspect, the invention provides an energy absorber device for a fall arrest system, the device comprising:
an energy absorber having a coil-form portion and an elongate tongue portion extending in a linear direction at the periphery of the coil-form portion;
a rotatable deformer element positioned between the coil-form portion and an elongate tongue portion, wherein in deployment the energy absorber is drawn to plastically deform about the rotatable deformer element.

According to a further aspect the invention provides an energy absorber device for a fall arrest system, the device comprising:
an energy absorber having a coil-form portion and an elongate tongue portion extending in a linear direction at the periphery of the coil-form portion;
a deformer element positioned between the coil-form portion and an elongate tongue portion, wherein in deployment the energy absorber is drawn to plastically deform about the deformer element; wherein the energy absorber extends to be curved about the deformer element so as to be curved in an opposed sense to the curvature of the coil-form portion of the absorber adjacent to the portion of the absorber wrapped about the deformer.

According to a further aspect, the present invention provides an energy absorber for a fall arrest device, the energy absorber comprising:
a coil-form portion having a coil axis; and,
an elongate tongue portion extending in a linear direction at the periphery of the c oil-form portion;
a curved linking portion spacing the tongue portion from the periphery of the coil-form portion of the energy absorber; the curved linking portion being curved in an opposed sense to the curvature of the coil form portion adjacent the curved linking portion.

The invention will now be further described by way of example only and with reference to the accompanying drawings, in which:

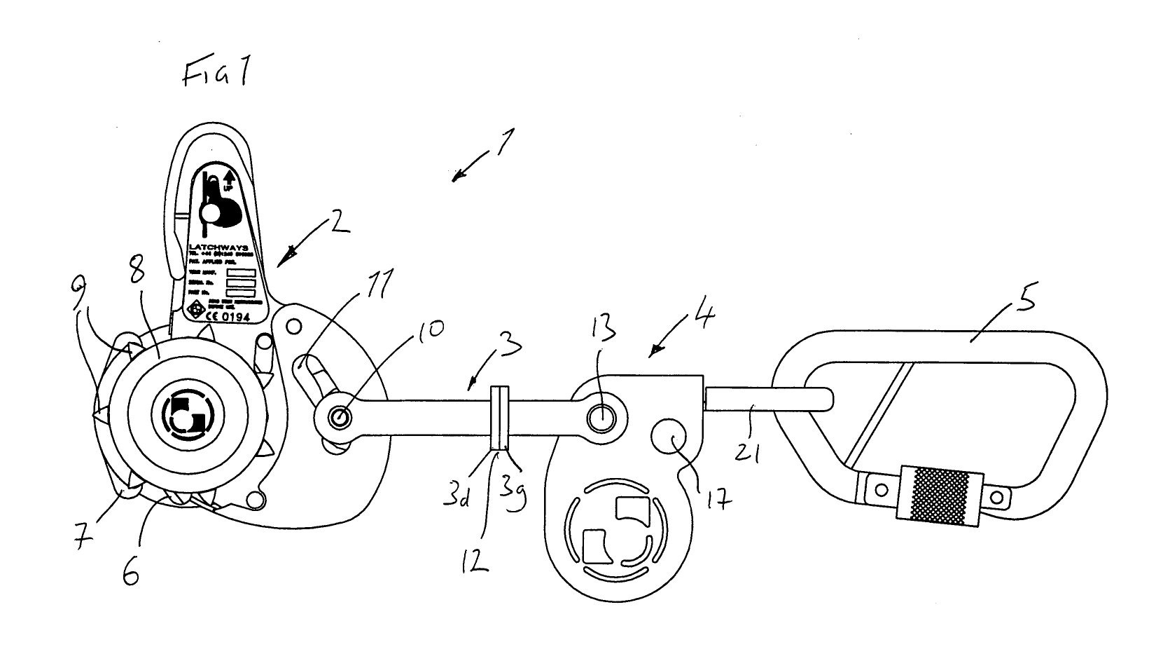

FIG. 1 is a schematic view of a fall arrest safety system in accordance with the present invention;

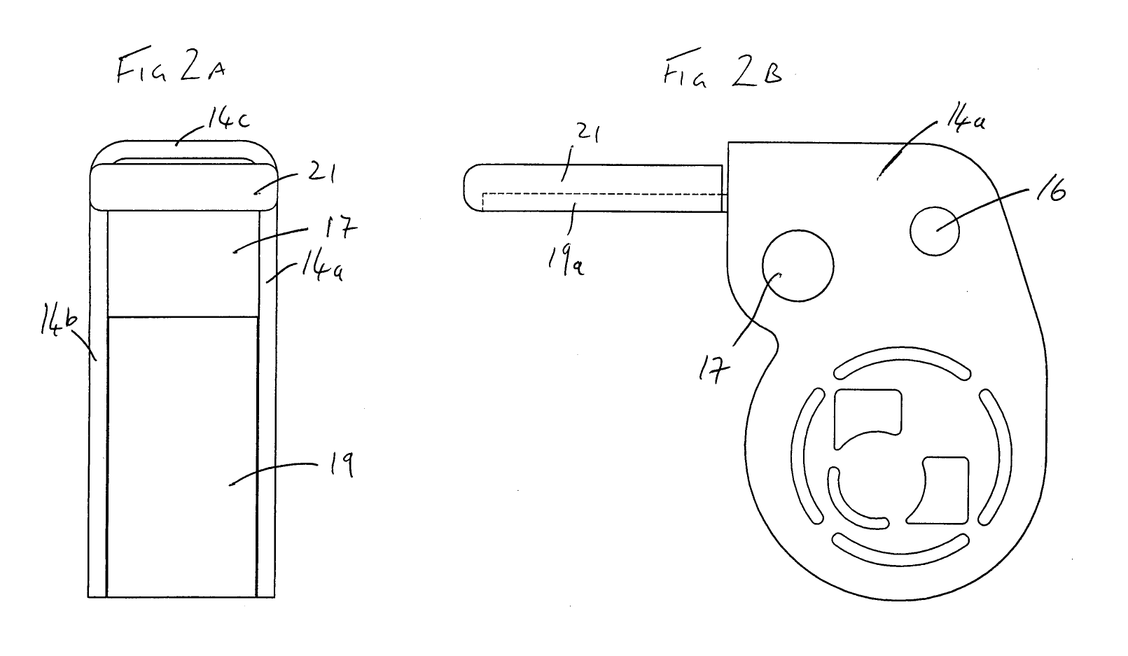

FIGS. 2A and 2B are side and underside views respectively of the energy absorber device in accordance with the invention;

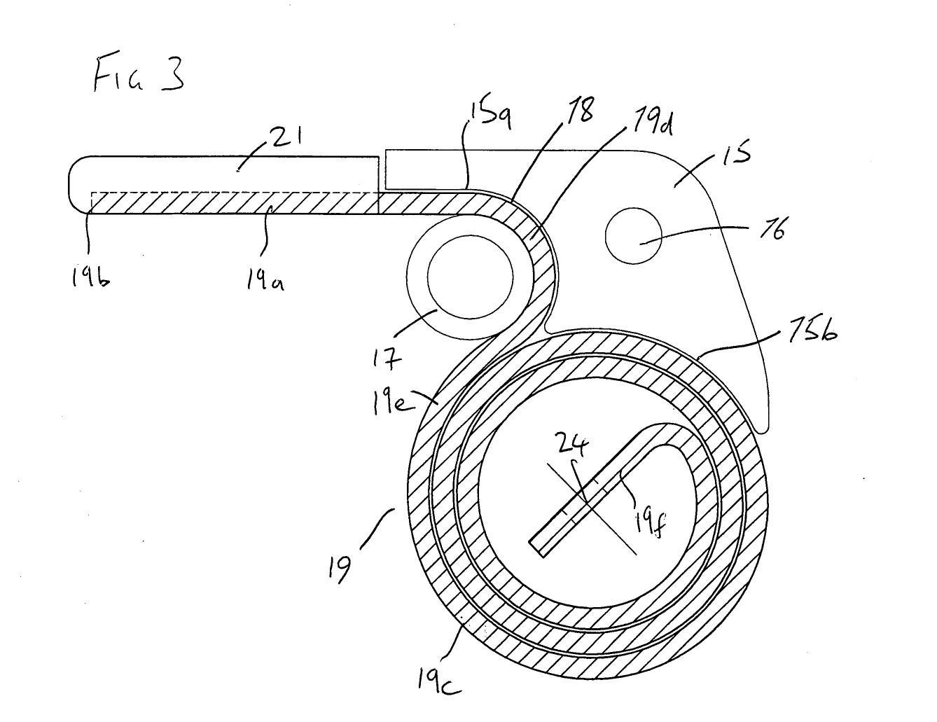

FIG. 3 is a schematic sectional view of the energy absorber device showing an energy absorber in accordance with the invention;

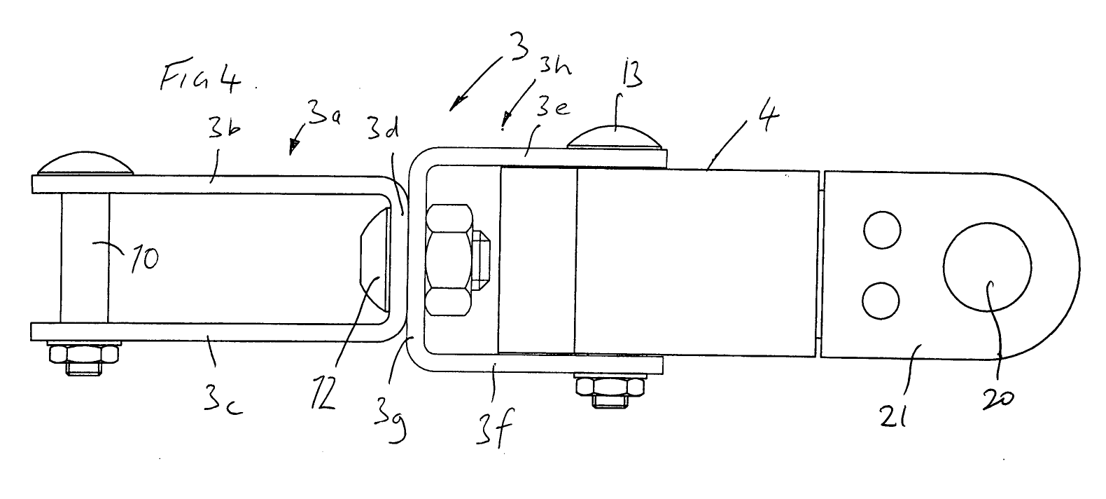

FIG. 4 is a plan view of a part of the system showing the rigid connection between the energy absorber device and the traveller device.

Referring to the drawings, there is shown a fall arrest system 1 comprising a traveller device 2, connected by a rigid arm 3 to an energy absorber device 4. A karabiner 5 is attached to the energy absorber device 4 enabling attachment to a lanyard or safety harness worn by a user.

The traveller device is of a known star wheel self locking type as disclosed in general terms for example in WO95/26784. The traveller device 2 as shown in FIG. 1 includes a cam member 6 which is pivotable on bosses located in a pair of side plates disposed on either side of the can member. Biasing means in the form of a tension spring (not shown) is attached to the cam member at one end and to a fixed member such as a dowel at the other end. The effect of the biasing means is to bias the pivotal movement of the cam member in a direction towards the lock-on condition in which a safety line is tightly gripped by the traveller device 2 between the cam member 6 and a slipper 7 also secured between the side plates.

The rotatable star wheel 8 prevents the safety line cable from being dislodged from the traveller device 2. It comprises a central hub which receives a spindle or bolt and a plurality of evenly-spaced radially-projecting petals 9. As shown, the disposition of the wheel in relation to the body member is such that the petals execute a circular path which overlies the safety line retaining recess between the slipper 7 and the cam member 6.

FIG. 1 shows the traveller device 2 with the cam member 6 in the raised position in which there is no engagement with the safety line. In normal use, under neutral loading, the cam member is urged into the lock-on position by a combination of gravity acting on the cam centre of gravity and tension in the tension spring. In this condition, the attachment device is firmly locked-on to the safety line for all fall-arrest situations.

The arm 3 is pivotally connected at pivot 10 to the body of the cam member 6 (which is obscured by the side plate in FIG. 1). The operation is such that as the pivot point 10 moves in the slot 11 (in response to movement of the arm 3) the cam body 6 is caused to move. During normal climb or descent, the force on the connecting pivot 10 of the cam member is due to the weight of the device. This force, and its direction is sufficient to overcome the downward (opposing) force of the cam member and thus moves the cam member to release the safety line lock-on. In such a position, normal climb or descent is possible without the cam member locking on. In the event of a fall, the weight of the cam member 6 and the action of the tension spring causes the device to lock on to the safety line. Such operation is known in prior art systems.

As shown most clearly in FIG. 4, the rigid connector arm 3 is joined in 2 parts and comprises a first bracket portion 3a having a pair of spaced side elements 3b 3c and a bridge 3d. A second bracket part of the arm 3h comprises a second pair of spaced side elements 3e and 3f and a connecting bridge 3g. The bridges are connected at a swivel connection provided by means of bolt 12. The side elements 3e and 3f of the arm part 3e are pivotally connected to the chassis of the energy absorber device 4 at a pivot connection provided by bolt 13. The use of rigid brackets 3a 3h to make up rigid arm 3 ensures that the energy absorber device 4 and the traveller device 2 remain separated by a fixed distance and do not come onto contact with one another, which could otherwise result in impact damage to one or both absorber device 4 and the traveller device 2.

The energy absorber device 4 comprises a chassis housing defined by a pair of side plates 14a, 14b and a connecting bridge 14c. The mounting bolt 13 passes through opposed apertures in the side plates 14a 14b and serves also to mount the energy absorber by passing through an aperture 16 in a guide block 15 in order to mount the guide block 15 with respect to the chassis housing. A roller bearing 17 is also mounted between the side plates 14a 14b of the chassis housing. When mounted to the chassis an arcuate guide slot 18 is defined between the cylindrical surface of the roller bearing 17 and the arcuate guide surface 15a of the guide block 15. The guide block 15 includes a second arcuate guide surface 15b spaced from, and of greater radius of curvature than, the first guide surface 15a.

The chassis housing, guide block 15 and roller bearing 17 together retain an energy absorber strip 19 that is shown in an un-deployed condition, most clearly, in FIG. 3. The energy absorber strip 19 is formed of stainless steel strip. In the un-deployed condition the energy absorber strip 19 has a tongue portion 19a having a free end 19b. The tongue portion 19a is connected to a coil-form portion 19c. The tongue portion 19a extends in a linear direction substantially parallel to a tangent of the coil-form portion 19c. A linking portion 19d of the absorber strip is curve form to extend about the roller bearing 17, linking the coil form portion 19c and the tongue portion 19a of the absorber strip. The curved linking portion 19d of the strip is curved in an opposed sense to the curvature of the coil-form portion 19e adjacent the curved linking portion. In this way the strip is formed to have a serpentine or S shaped zone. The arrangement is such that the curved linking portion 19d of the strip is wrapped around the roller bearing through greater than 90 degrees, preferably to between 90 and 180 degrees. The end 19f of the energy absorber strip is secured to an anchor disc (not shown) fixed to be rotatable internally of the chassis housing. An aperture 24 for a securing bolt is provided for this purpose. The anchor disc is retained by a rotatable boss (not shown) extending between the side plats 24a 24b to permit the anchor disc to rotate.

The tongue 19a of the energy absorber strip, in the un-deployed state, extends from the chassis housing of the energy absorber device 4 and is provided with an eyelet 20 through which the karabiner 5 can be secured. An aluminium sheath 21 is fitted about the tongue portion 19a of the energy absorber strip. The sheath is provided with apertures to match up with the eyelet 20.

In the event of a fall arrest event occurring, the movement of the arm 3 causes the cam member 6 of the traveller 2 to pivot as the pivot point 10 moves in the slot 11 (in response to movement of the arm 3). The weight of the cam member 6 and the action of the tension spring causes the device to lock on to the safety line. The impulse on the system caused by the weight of the user suspended from the traveller now fixed to the safety line, being over the predetermined limit required to deploy the energy absorber strip, causes the energy absorber strip 19 to be drawn out of the chassis housing from the tongue portion end. As this happens the length of the strip in the coil form portion diminishes as the coil form-portion rotates on the rotatable anchor disc. The length of strip is drawn past the rotatable bearing 17 passing along the serpentine deployment path through the guide slot 18. In so doing the energy absorber strip is plastically deformed from its coil-form un-deployed state to a linear deployed state. In so doing the separation distance between the eyelet 20 and the chassis housing of the energy absorber device increases.

The invention provides a particularly effective means of providing an energy absorber capability for a fall arrest system of the type having a traveller with an auto lock arrangement for vertical or upwardly situated safety lines. The invention enables a robust plastically deformable energy absorber to be used. The use of a coil-form stored absorber reduces overall size and the deployment to a linear state by passing through a serpentine guide path ensures effective absorption of energy. The provision of a roller bearing also increases efficiency. The rigid connection between the traveller and the energy absorber device prevents accidental damage that could otherwise be caused by one impacting on the other during normal use.

1. A fall arrest safety system comprising:
a traveller device arranged to travel along a safety line and including a securing arrangement deployable in response to a fall event to secure the traveller device in fixed position on the safety line; and
an energy absorber device connected intermediately between the traveller device and a user, the energy absorber device including a plastically deformable energy absorber deployable in response to a fall event to plastically deform from a stowed orientation to a deployed orientation.

2. A fall arrest system according to claim 1, wherein in deployment the energy absorber acts to lengthen the separation distance between the point of attachment to the user and the traveller device.

3. A fall arrest system according to claim 1 further comprising a rigid connection arm extending between the traveller device and the energy absorber device.

4. A fall arrest system according to claim 3, wherein the rigid connection arm is pivotally connected to one or both of the traveller device and the energy absorber device.

5. A fall arrest system according to claim 3, wherein movement of the rigid connection arm effects deployment of the securing arrangement to secure the traveller device in fixed position on the safety line.

6. A fall arrest system according to claim 1, wherein the energy absorber comprises a metallic element deployed to be drawn along a deployment path about a deformer to a plastically deformed extended state in order to absorb energy in a fall arrest event.

7. A fall arrest system according to claim 1, wherein the energy absorber device includes an energy absorber comprising a coil form element which is deployed from a coil form state to a plastically deformed extended state in order to absorb energy in a fall arrest event.

8. A fall arrest system according to claim 6, wherein in deployment the energy absorber is drawn to plastically deform about a rotatable deformer element.

9. A fall arrest system according to claim 1, wherein in an un-deployed state the energy absorber has:
a coil-form portion having a coil axis; and,
an elongate tongue portion extending in a linear direction at the periphery of the coil-form portion.

10. A fall arrest system according to claim 9, wherein the elongate tongue portion is spaced from the periphery of the coil-form portion of the energy absorber.

11. A fall arrest system according to claim 9, wherein intermediate between the coil form portion and the linear portion, the energy absorber has a curved linking portion.

12. A fall arrest system according to claim 11, wherein the curved linking portion;
extends to be curved about a deformer element; and/or
is curved in an opposed sense to the curvature of the coil form portion adjacent the curved linking portion.

13. A fall arrest system according to claim 1, wherein the energy absorber comprises a plastically deformable metallic strip.

14. A fall arrest system according to claim 1, wherein the energy absorber comprises connection means for connecting the energy absorber to a user connected item.

15. A fall arrest system according to claim 14, wherein the connection means comprises an eyelet provided through the energy absorber.

16. A fall arrest system according to claim 1, wherein the energy absorber is provided in a housing comprising the energy absorber device, the energy absorber being drawn out of the housing during deployment to a plastically deformed extended state in order to absorb energy in a fall arrest event.

17. A fall arrest system according to claim 16, wherein in an un-deployed state an elongate tongue portion of the energy absorber extends in a linear direction to project from the housing.

18. A fall arrest system according to claim 17, wherein the elongate tongue portion projecting from the housing is provided with one or both of:
a cover coating or sheath; and
an eyelet for connection to a karabiner, lanyard or other connection device.

19. A fall arrest system according to claim 1, wherein the traveller device includes a clamp or grip element which is deployed to clamp or grip the safety line to secure the traveller device in the fixed position on the safety line in response to a fall event.

20. A fall arrest system according to claim 1 for use with an upwardly extending safety line.

21. An energy absorber device for a fall arrest system, the device comprising:
a housing; and
an energy absorber disposed in the housing and having a coil-form portion and an elongate tongue portion extending in a linear direction at the periphery of the coil-form portion, the elongate tongue portion of the energy absorber being arranged to extend to project from the housing and provided with means for connection to a karabiner, lanyard or other connection device.

22. An energy absorber device for a fall arrest system, the device comprising:
an energy absorber having a coil-form portion and an elongate tongue portion extending in a linear direction at the periphery of the coil-form portion; and
a rotatable deformer element positioned between the coil-form portion and an elongate tongue portion, wherein in deployment the energy absorber is drawn to plastically deform about the rotatable deformer element.

23. An energy absorber device according to claim 22, wherein the energy absorber extends to be curved about the rotatable deformer element so as to be curved in an opposed sense to the curvature of the coil form portion of the absorber adjacent to the portion of the absorber wrapped about the deformer.

24. An energy absorber device for a fall arrest system, the device comprising:
an energy absorber having a coil-form portion and an elongate tongue portion extending in a linear direction at the periphery of the coil-form portion; and
a deformer element positioned between the coil-form portion and an elongate tongue portion, wherein in deployment the energy absorber is drawn to plastically deform about the deformer element; wherein the energy absorber extends to be curved about the deformer element so as to be curved in an opposed sense to the curvature of the coil-form portion of the absorber adjacent to the portion of the absorber wrapped about the deformer.

25. An energy absorber for a fall arrest device, the energy absorber comprising:
a coil-form portion having a coil axis;
an elongate tongue portion extending in a linear direction at the periphery of the coil-form portion; and
a curved linking portion spacing the tongue portion from the periphery of the coil-form portion of the energy absorber; the curved linking portion being curved in an opposed sense to the curvature of the coil form portion adjacent the curved linking portion.

26. An energy absorber according to claim 25 formed of metallic strip material.

27. A fall arrest system according to claim 14, wherein the user connected item is selected from the group consisting of a karabiner and a lanyard.
